(19) United States
(12) Patent Application Publication
(10) Pub. No.: US 2016/0270425 A1
(43) Pub. Date: Sep. 22, 2016

(54) DECALCIFICATION OF PASTURE GRASS FOR FOOD AND FUEL

(71) Applicant: Joel Steven Goldberg, Hillsborough, NC (US)

(72) Inventor: Joel Steven Goldberg, Hillsborough, NC (US)

(21) Appl. No.: 15/172,251

(22) Filed: Jun. 3, 2016

(51) Int. Cl. A23J 1/00; C10L 5/44

(52) U.S. Cl. CPC A23J 1/007; C10L 5/447; A23L 1/212; C10L 2290/02; C10L 2290/544; A23V 2002/00

(57) ABSTRACT

Worldwide food shortages are predicted by the year 2050. The most seriously affected populations will be those who live in sub Saharan Africa and South Asia. Obtaining food and fuel from perennial grasses is advantageous. Unlike common grain crops the perennial pasture grasses are natural flora and do not need to be planted yearly. Until now, economic processing of perennial grasses for food and fuel was not considered possible. In this invention it was discovered that brief treatment of grasses with citrate softens the grasses presumable because the citrate chelates the calcium bound to pectin. With the integrity of the pectin disrupted, the cellulose is destabilized and the citrated treated grass can be manually extracted. The extract contains all essential amino acids required for humans and quantitative calculations show that the process can provide enough protein to meet adult male minimum daily requirements.

### CROSS-REFERENCES TO RELATED APPLICATIONS

None

### FEDERALLY FUNDED RESEARCH

Not applicable

### BACKGROUND OF THE INVENTION

It is predicted that by the year 2050 significant food shortages will exist on earth. (Ringler 2010) As with many other resource allocations, wealthy societies will be marginally affected, but poor societies that do not have geographic, climactic and infrastructure advantages such as sub-Saharan Africa and South Asia will feel the full brunt of the famine.

As a source of food and fuel, pasture grasses have significant advantages over grains such as rice, wheat and barley. In most climates, pasture grasses are evergreen perennials that can be efficiently harvested with basic agricultural machinery. Pasture grasses do not require yearly replanting which is labor intensive, costly and subject to the risks of germination.

Unlike cows, sheep, goats and other grazing animals, humans cannot efficiently digest cellulose that envelop plant cells which contain proteins and amino acids.

As a fuel, pasture grasses can be easily converted into biochar to construct low cost and efficient fuel cells. The addition of biochar obtained from the oxygen deficient combustion of the by-product of grass extraction is a component of the renewable, rechargeable and inexpensive fuel cell previously described. (Goldberg 2015) The chemistry of this fuel cell is unique because the cell consumes water, oxygen and zinc without requiring an electrolyte: The cell reaction is:

Zn+1/2O₂+H₂O [symbol] Zn⁺²+2OH⁻

contrasted with the standard reaction for a zinc air fuel cell:

2Zn+O₂ [symbol] 2ZnO.

With periodic addition of water, these fuel cells can produce electricity for years because the zinc and hydroxide waste products are buffered by adsorption onto the micropore structure of the biochar. The internal ionic resistance of the fuel cell therefore rises extremely slowly.

Numerous inventions have attempted to extract proteins from grasses. Some of the problems include separation methods that are not feasible. Methods to isolate proteins, amino acids and sugars from pasture grasses include maceration and compression of leaves to express juice and extraction with expensive and toxic solvents such as acetone, methanol, or ethanol. None of these methods have been considered cost effective on a large scale.

### PRIOR ART

| | Acid | | |
|---|---|---|---|
| Pat. | addition | Fermentation | Centrifugation |
| U.S. Pat. No. | Yes | Yes | |
| 4,359,530 A | | | |
| U.S. Pat. No. | Yes | | Yes |
| 4,006,078 A | | | |
| U.S. Pat. No. | Yes | | Yes |
| 6,740,740 | | | |
| B2 | | | |
| This | No | No | No |
| invention | | | |

Previously, it was shown that calcium can be spontaneously chelated from bone at 37° C. with solutions of sodium citrate or sodium citrate/citric acid buffer. (Goldberg 2016) During this reaction there are minimal changes in net ionic bond energies. (ΔH) The chelation of calcium with citrate is largely driven by a change in entropy. (−TΔS) Chelation of calcium with citrate is used to anticoagulate blood samples prior to centrifugation. Chelation of calcium by citrate is also used as a cleaning solution and water softener. The true versatility of this chemical reaction has not been appreciated in the literature.

In this invention it was discovered that ionic bonds of calcium that stabilize pectin can be rapidly and spontaneously broken with citrate. (FIG. 1) In plants, pectin cross-links cellulose. (FIG. 2) Citrate can chelate calcium that has stabilized pectin cross-linking so as to disrupt the cellulose structure enabling amino acid and proteins to be efficiently and cheaply extracted. Citrate chelation of calcium significantly softens the structure of perennial grass permitting juice extraction with a manual (non-electric) juicing device.

### DESCRIPTION OF THE DRAWINGS

FIG. 1 shows the cross-linking of pectin by calcium ions

FIG. 2 shows the cross-linking of cellulose by pectin. Label 1 is the cross-linking of pectin by calcium ions. Labels 2 and 3 are pectin. Label 4 is hemicellulose. Label 5 is cellulose.

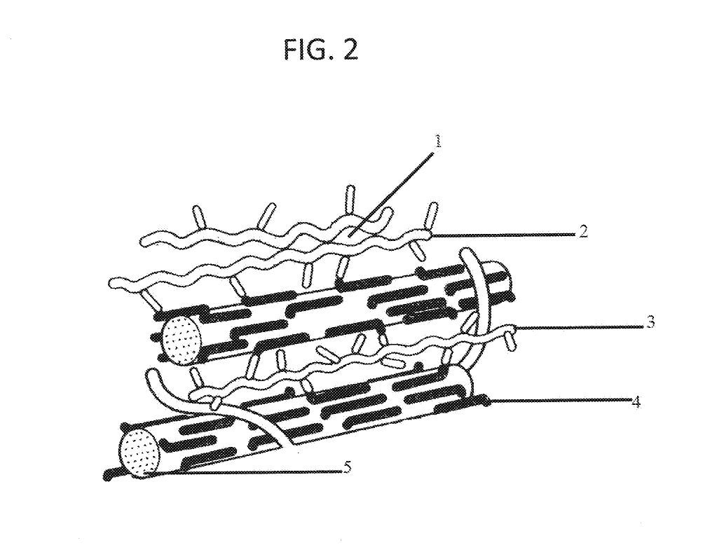

### DETAILED DESCRIPTION OF THE INVENTION

This invention is a cost effective and simple method to both extract food and obtain biochar from perennial grasses. The cost savings from harvesting perennial pasture grasses compared to growing and harvesting traditional grain crops is enormous. These grasses are natural flora in many parts of the world and do not need to be replanted. These grasses can be maintained with little intensive farming.

This invention also describes a method to convert the by-product of citrate treated pasture grass extract into biochar that can be used to produce clean electricity.

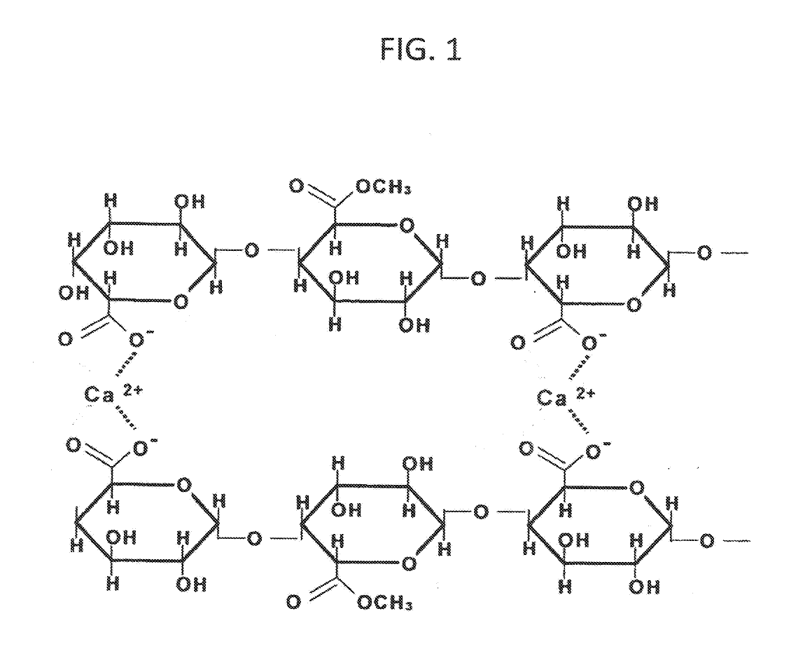

Without chemical processing, pasture grasses cannot be manually juiced because of the rigid cellulose structure. In this invention perennial ryegrass was harvested, dried and immersed in citrate solutions. (See experimental section) It is proposed that the citrate chelates calcium that supports the structure of pectin molecules. (FIG. 1) As the pectin is destabilized from the calcium, cellulose is likewise destabilized permitting manual extraction of the juice from the grass. The juice is filtered and then dried. The crude protein analysis of the dried freshly harvested grass was 12.25% in contrast to the maximum crude protein analysis of citrate treated grass between 19.72-20.95%. The dried extract contains all essential amino acids required for humans.

### Benefits to Society

If predictions are correct, with an increasing global population, the food capacity of the earth will be insufficient by the year 2050. The manual extraction of protein from grasses may be needed to supply food to the poorest underdeveloped segments of the population. For years many have sought a method to break down cellulose and extract protein from plants. This invention demonstrates that citrate can destabilize the cellulose structure of perennial ryegrass to permit manual extraction. Perennial grasses are naturally found around the globe and they do not require laborious care and expensive annual replanting.

The fiber by-product of this extraction can be easily combusted in an oxygen deficient environment to produce biochar that can be recycled as a charcoal substitute or can be used to construct inexpensive, rechargeable, renewable zinc/natural carbon/graphite fuel cells. (Goldberg 2015) These cells can produce electricity for years consuming water, oxygen and zinc because biochar adsorbs the waste products of zinc and hydroxide ions.

The experimental section is a quantitative analysis of the amino acids and protein contained in the juice extracted from pasture grass.

### Experimental Section

Freshly cut perennial ryegrass (Lolium perenne) was allowed to dry for three days. Three 50 g portions of the grass were immersed for 24 hours in solutions of 200 ml of 1M sodium citrate, 0.1 M sodium citrate or sodium citrate/citric acid pH 7.0 buffer with buffer strength of 50 mM. The portions were washed in water and then fed into a manual juicing device (Miracle Exclusives Stainless Steel Wheat Grass Juicer, MJ445, Danbury, Conn. 06810). The extracts were filtered through a porcelain filter and then dried in glass dishes at 100° C. The dried extract was scraped from the dishes and sent for analysis of protein and free amino acids.

Analysis of perennial ryegrass hay prior to citrate processing:

TABLE 1

| | |
|---|---|
| Crude protein | 12.25% |
| Calcium | 0.39% |
| Phosphorus | 0.24% |
| Sulfur | 0.19% |
| Magnesium | 0.29% |
| Sodium | 0.01% |
| Potassium | 2.18% |
| Copper | 5.00 ppm |
| Iron | 361.00 ppm |
| Manganese | 82.00 ppm |
| Zinc | 16.00 ppm |

Table 1 Analysis of perennial ryegrass hay, NCDA&CS Feed/Forage Office, Raleigh, NC 27699-1070

Amino acid analysis of citrate treated extract of perennial ryegrass hay:

TABLE 2

| | 1.0M citrate | 0.1M citrate | Citrate buffer |
|---|---|---|---|
| | (3.8 g) | (2.1 g) | (2.1 g) |
| % Crude protein | 19.72 | 6.79 | 20.95 |
| Amino acids | | | |
| W/W % = g/100 g | | | |
| Taurine | 0.05 | 0.04 | 0.07 |
| Hydroxyproline | 0.06 | 0.02 | 0.04 |
| Aspartic acid | 1.09 | 0.42 | 1.07 |
| Threonine | 0.50 | 0.18 | 0.49 |
| Serine | 0.36 | 0.16 | 0.29 |
| Glutamic acid | 1.45 | 0.67 | 1.94 |
| Proline | 1.27 | 0.40 | 1.23 |
| Glycine | 0.81 | 0.24 | 0.82 |
| Alanine | 1.22 | 0.31 | 1.20 |
| Cysteine | 0.15 | 0.04 | 0.14 |
| Valine | 1.08 | 0.26 | 0.94 |
| Methionine | 0.22 | 0.06 | 0.23 |
| Isoleucine | 0.71 | 0.18 | 0.65 |
| Leucine | 1.12 | 0.34 | 1.02 |
| Tyrosine | 0.45 | 0.14 | 0.49 |
| Phenylalanine | 0.71 | 0.17 | 0.67 |
| Hydroxylysine | 0.65 | 0.15 | 0.62 |
| Ornithine | 0.07 | 0.02 | 0.14 |
| Lysine | 0.61 | 0.17 | 0.59 |
| Histidine | 0.22 | 0.07 | 0.25 |
| Arginine | 0.57 | 0.15 | 0.45 |
| Tryptophan | 0.09 | 0.04 | 0.15 |
| Total | 13.46 | 4.23 | 13.49 |

Table 2 Protein and amino acid analysis of citrate treated perennial ryegrass extract, Experiment Station Chemical Laboratories, University of Missouri, Columbia, MO 65211-7170

Maximum crude dried protein from extract of 50 g dried perennial ryegrass hay treated with 1M sodium citrate: 19.72 g/100 g×3.8 g=0.75 g protein.

Required grams of perennial ryegrass hay processed with citrate to meet adult male minimum requirement of protein: 0.75 g protein/50 g hay=56 g protein per day/x g hay=x=3,733 g hay per day.

All nine essential amino acids for humans (histidine, isoleucine, leucine, lysine, methionine, phenylalanine, threonine, tryptophan, and valine) were found in citrate processed perennial ryegrass hay extract. However, depending upon the species of grass, extracts of citrate treated grass may contain harmful quantities of cyanide and silica.

Cost of Sodium Citrate

At the time of this writing, food grade sodium citrate (trisodium citrate) can be purchased at 600 USD per metric ton.

### REFERENCES

Goldberg, J. S. (2015). U.S. patent application Ser. No. 14/057,506 A1. Washington, D.C.: USPTO

Goldberg, J. S. (2016). U.S. patent application Ser. No. 14/991,931 A1. Washington, D.C.: USPTO

Ringler, C. (2010), Climate Change and Hunger: Africa's Smallholder Farmers Struggle to Adapt Changement climatique et famine: les petits exploitants africains peinent à s'ajuster Klimawandel and Hunger: Kleinbauern in Afrika haben Schwierigkeiten bei der Anpassung. EuroChoices, 9: 16-21. doi: 10.1111/j.1746-692X.2010.00175.x

Having described my invention, I claim:

1. A manual method to extract protein from grass comprising:
a. treating the grass with citrate in an aqueous solution
b. extracting juice from the grass with a manual device
c. filtering the grass extract.

2. The method of claim 1, where the concentration of citrate in water is between 0.5 M and 1.0M.

3. A manual method to produce biochar from grass comprising:
a. treating the grass with citrate in an aqueous solution
b. extracting fiber from the grass with a manual device
c. burning the extracted fiber in an oxygen deficient environment.
